(19) United States
(12) Patent Application Publication
(10) Pub. No.: US 2009/0325139 A1
(43) Pub. Date: Dec. 31, 2009

(54) COURSE HUB FOR ADVANCED ASSESSMENT OF LEARNING

(75) Inventors: Cliff Lloyd, Woodinville, WA (US); Robert Dietz, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,464

(22) Filed: Jun. 26, 2008

(51) Int. Cl. G09B 3/00

(52) U.S. Cl. 434/353; 434/322

(57) ABSTRACT

A method for implementing a course hub can include generating a three dimensional activity grading object. Furthermore, an assessable learner process journal can be generated as part of implementing the course hub. In addition, the implementing of the course hub can include generating a plurality of communication zones. Moreover, a “what if” assignment grade modeling can be generated as part of implementing the course hub.

### BACKGROUND

The traditional grade book offered by typical electronic institutional Learning Management Systems supports recording of a single grade value and comment per task, which are associated with each student. Furthermore, any iterations on this grade or comment are simply overwritten by the newest entry with all history of the previous interaction lost. Additionally, it is pointed out that the services provided by typical electronic institutional Learning Management Systems have other shortcomings which make it more difficult for an educator to assess each learner's true ability beyond the final work product.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An embodiment of the present technology can include a method for implementing a course hub that produces advanced assessment along with learner and educator interaction. For example, the course hub can be implemented as an application within an institutional course management system. The course hub can be implemented in a wide variety of ways. In one embodiment, the course hub can be implemented to include and generate the following: a three dimensional activity grading object; an assessable learner process journal; a plurality of context sensitive communication zones; and “what if” assignment grade modeling. It is pointed out that the course hub can be implemented to include and generate other functionality associated with the course management system.

Such a method for implementing a course hub can enable advanced assessment of learners along with enabling interaction between learner and educator. In this manner, the educator is enabled to make informed judgments and assessments of each learner's true ability that is materially in excess of simply viewing the final work product.

### DESCRIPTION OF THE DRAWINGS

FIG. 1 is a block diagram of an example system in accordance with various embodiments of the present technology.

FIG. 2 is a block diagram of another example system in accordance with various embodiments of the present technology.

FIG. 3 illustrates an example user interface in accordance with various embodiments of the present technology.

FIG. 4 illustrates an example plan and assign window in accordance with various embodiments of the present technology.

FIG. 5 illustrates an example monitor and access window in accordance with various embodiments of the present technology.

FIG. 6 illustrates an example three dimensional activity grading object window in accordance with various embodiments of the present technology.

FIG. 7 illustrates an example student view window in accordance with various embodiments of the present technology.

FIG. 8 illustrates another example student view window in accordance with various embodiments of the present technology.

FIG. 9 illustrates yet another example student view window in accordance with various embodiments of the present technology.

FIG. 10 illustrates still another example student view window in accordance with various embodiments of the present technology.

FIG. 11 illustrates an example assessable learner process journal in accordance with various embodiments of the present technology.

FIG. 12 is a block diagram illustrating a process journal concept in accordance with various embodiments of the present technology.

FIG. 13 is an example flow diagram of operations performed in accordance with various embodiments of the present technology.

### DETAILED DESCRIPTION

Reference will now be made in detail to embodiments of the present technology for implementing one or more course hubs, examples of which are illustrated in the accompanying drawings. While the technology for implementing one or more course hubs will be described in conjunction with various embodiments, it will be understood that they are not intended to limit the present technology for implementing one or more course hubs to these embodiments. On the contrary, the presented embodiments of the technology for implementing one or more course hubs are intended to cover alternatives, modifications and equivalents, which may be included within the scope of the various embodiments as defined by the appended claims. Furthermore, in the following detailed description, numerous specific details are set forth in order to provide a thorough understanding of embodiments of the present technology for implementing one or more course hubs. However, embodiments of the present technology for implementing one or more course hubs may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the detailed description, discussions utilizing terms such as “producing”, “retrieving”, “identifying”, “creating”, “receiving”, “generating”, “determining”, “performing”, “building”, “utilizing”, “processing”, “presenting”, “modifying”, “changing”, “altering”, “inputting”, “outputting”, or the like, refer to the actions and processes of a computer system or similar electronic computing device. In one embodiment, the computer system or similar electronic computing device can manipulate and transform data represented as physical (electronic) quantities within the computer system's registers and/or memories into other data similarly represented as physical quantities within the computer system memories and/or registers or other such information storage, transmission, or display devices. Some embodiments of the present technology for implementing one or more course hubs are also well suited to the use of other computer systems such as, for example, optical and virtual computers.

### Example Computer System Environment

All or portions of some embodiments of the technology for implementing one or more course hubs can be composed of computer-readable and computer-executable instructions that reside, for example, in computer-usable media of a computer system. It is pointed out that various embodiments of the present technology for implementing one or more course hubs can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems, low-cost computer systems, high-end computer systems, and the like. Note that in some embodiments, the computer system can include, but is not limited to, one or more processors, computer usable volatile memory, computer usable non-volatile memory, computer usable mass data storage (e.g., a magnetic or optical disk and disk drive), and a display device. Furthermore, the computer system can be adapted to receive peripheral computer readable media such as, for example, a compact disc, a DVD, flash memory, a floppy disk, and the like. In some embodiments, for example, all or part of the present technology for implementing one or more course hubs can be stored as an application or any number of modules by computer usable non-volatile memory, computer usable mass data storage, and/or peripheral computer readable media. Likewise, in some embodiments, all or part of the present technology for implementing one or more course hubs may be stored at a separate location from the computer and accessed via, for example, a coupling to one or more networks and/or the internet.

### Overview

Various embodiments in accordance with the present technology can include a Course Hub which can implement one or more of the following features: a three dimensional activity grading object, an assessable learner process journal, a context sensitive communication zones, and a “what if” assignment grade modeling, but is not limited to such. It is noted that the Course Hub can be implemented in one embodiment as a component of a larger, end-to-end application that replaces the traditional planning, assignment and grading workflow aspects of an institutional Learning Management System. As such, in one embodiment, the Course Hub can be deployed by educational institutions as the main component of a course management solution. It is pointed out that the various embodiments of the Course Hub can also include the following additional features: course planning by units and outcomes, semester planning, standards support for playback and learner interaction, learner/educator assignment workflow (e.g., which can include assign, execute, submit, grade, and return), standards support for playback and learner interaction, and aspect based grading. Note that in one embodiment, the Course Hub module can be used in a “per course instance” context and as such can typically be used within an application framework that provides for audience targeting and an instance context, such as, Microsoft Office SharePoint Server (MOSS), Windows SharePoint Services (WSS), Office Live Workspaces, and MSN (The Microsoft Network) Spaces (also known as Windows Live Spaces).

### Example System

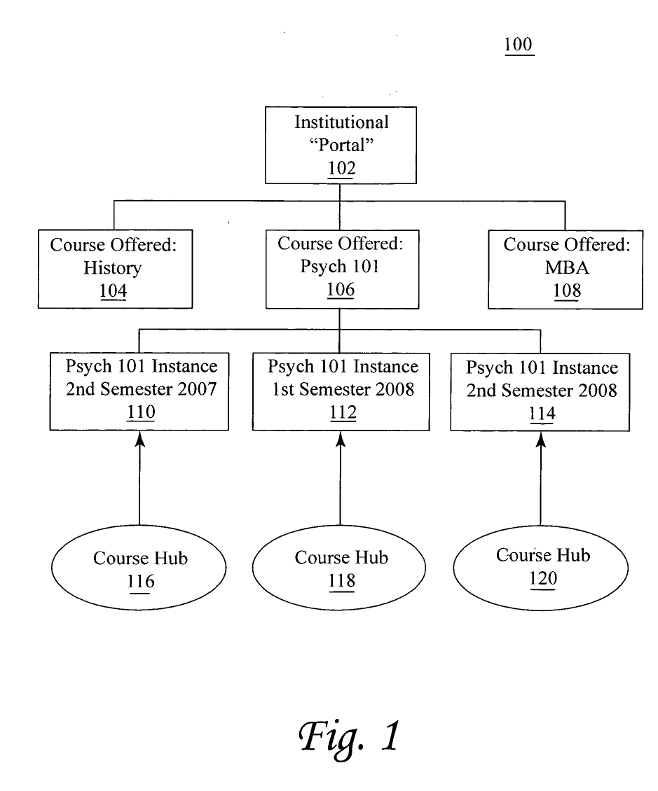

FIG. 1 is a block diagram of an example system 100 in accordance with various embodiments of the present technology. Specifically, system 100 illustrates that one Course Hub (e.g., 116) can be instantiated per instance of a course being offered by an institution. In one embodiment, the Course Hub can draw its user context from a grouping device within each course container. For example, in a MOSS or WSS context, each course container (e.g., implemented as a site) can contain a SharePoint group defining the educators and learners associated with the course instance.

The system 100 can include an institutional “portal” 102 (e.g., web site, network access point, and the like) that enables educators and learners associated with the institution to interact with one or more courses. For example, the system 100 can include, but is not limited to, a history course 104, a psychology 101 course 106, and a Master of Business Administration (MBA) course 108. Furthermore, within the system 100, each course offering can be implemented to include one or more different course instances associated with its course offering. For example, the psychology 101 course offering 106 can include, but is not limited to, a psychology 101 instance 110 for the second semester of 2007, a psychology 101 instance 112 for the first semester of 2008, and a psychology 101 instance 114 for the second semester of 2008. Additionally, within the system 100, one course hub can be instantiated per instance of a course being offered by an institution. For example in an embodiment of the system 100, the course hub 116 can be implemented (or instantiated) for the psychology 101 instance 110, a course hub 118 can be implemented (or instantiated) for the psychology 101 instance 112, and a course hub 120 can be implemented (or instantiated) for the psychology 101 instance 114. In this manner, each course hub can provide its functionality to the educators and learners associated with its corresponding course instance.

Within FIG. 1, the institutional portal 102 can be coupled to the history course 104, the psychology 101 course 106, and the MBA course 108. The psychology 101 course 106 can be coupled to the psychology 101 instance 110 for the second semester of 2007, the psychology 101 instance 112 for the first semester of 2008, and the psychology 101 instance 114 for the second semester of 2008. The course hub 116 can be coupled to the psychology 101 instance 110 for the second semester of 2007 while the course hub 118 can be coupled to the psychology 101 instance 112 for the first semester of 2008. Furthermore, the course hub 120 can be coupled to the psychology 101 instance 114 for the second semester of 2008. It is noted that the system 100 may not include all of the elements illustrated by FIG. 1. Additionally, the system 100 can be implemented to include one or more elements not illustrated by FIG. 1.

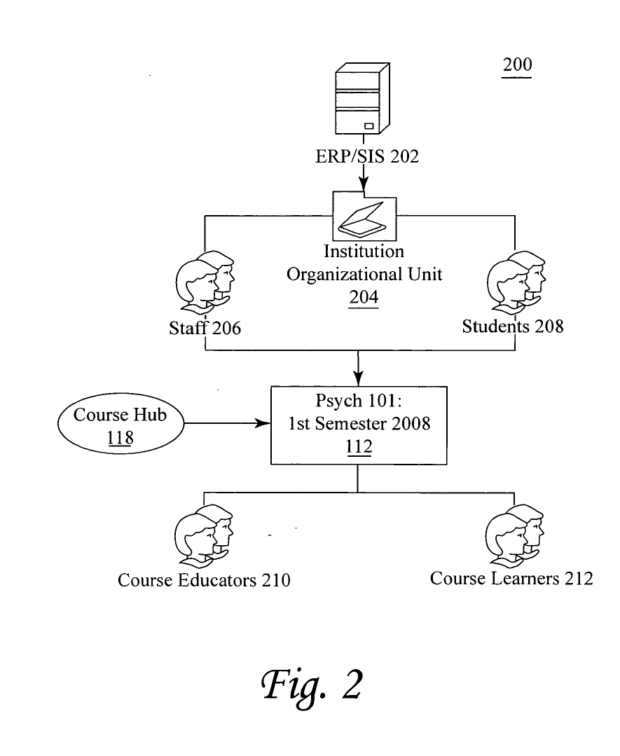

FIG. 2 is a block diagram of a system 200 in accordance with various embodiments of the present technology. Specifically, in one embodiment, the system 200 illustrates that the membership of the groups within the course container (e.g., 112) can be derived from an Intelligent Device Management (IDM) source such as: Active Directory (AD) or Lightweight Directory Access Protocol (LDAP), which in turn can be provisioned from an authoritative source 202 such as the Student Management, a student information system (SIS), or enterprise resource planning (ERP) system.

The system 200 can include the ERP/SIS 202 that can be coupled to an institution organizational unit 204, which can include one or more staff 206 and one or more students 208. Additionally, the institution organizational unit 204 can be coupled to provide the psychology 101 instance 112 for the first semester of 2008. The course hub 118 can be coupled to and implemented (or instantiated) for the psychology 101 instance 112 for the first semester of 2008. The system 200 can include one or more course educators 210 and one or more course learners 212 can communicate with or be coupled to the psychology 101 instance 112 for the first semester of 2008. It is noted that the system 200 may not include all of the elements illustrated by FIG. 2. Additionally, the system 200 can be implemented to include one or more elements not illustrated by FIG. 2.

### Example Course Hub User Interface

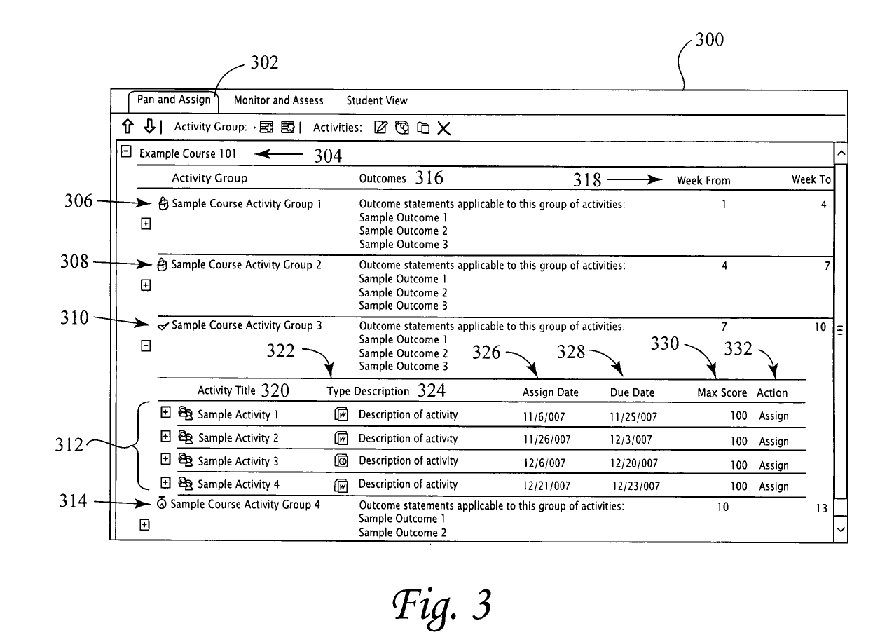

FIG. 3 illustrates an example user interface 300 in accordance with various embodiments of the present technology. In one embodiment, the user interface 300 can be implemented as a graphical user interface (GUI). Specifically, the user interface 300 illustrates the features and functionality that can be generated by a course hub (e.g., 118) for its corresponding course instance (e.g., 112) in a usage scenario. It is noted that the user interface 300 can include a “Plan and Assign” tab and corresponding window 302 that can be used to manage the basic workflow that supports the differentiators. As previously mentioned, the course hub (e.g., 118) can be implemented for a specific course instance, as indicated by label 304. Furthermore, by using the plan and assign window 302, educators can plan and assemble a course using outcome linked “building blocks”, referred to as Activity Groups (e.g., 306, 308, 310 and 314). It is noted that each of the Activity Groups 306, 308, 310 and 314 can be made up of one or more electronic activities (e.g., 312) that can be assigned to learners for execution, and ultimately graded by the educator.

Note that the plan and assign window 302 can include an “Outcomes” column 316 that corresponds to any outcome statements applicable to its corresponding group of activities of a particular activity group row (e.g., 306, 308, 310 or 314). Furthermore, the plan and assign window 302 can include one or more time frame columns 318 that delineate the time frame that learners will execute the particular corresponding activity group (e.g., 306, 308, 310 or 314).

Within FIG. 3, the expanded view of the one or more electronic activities 312 of each activity group (e.g., 310) can include, but is not limited to, an “Activity Title” column 320, a “Type” column 322 that indicates the type of the corresponding activity, a “Description” column 324 that describes the corresponding activity, an “Assign Date” column 326 that indicates the assignment date of the corresponding activity, a “Due Date” column 328 that indicates the due date of the corresponding activity, a “Max Score” column 330 that indicates the maximum score available for the corresponding activity, and an “Action” column 332 that can indicate whether or not the corresponding activity has been assigned.

It is noted that the plan and assign window 302 may not include all of the elements illustrated by FIG. 3. Additionally, the plan and assign window 302 can be implemented to include one or more elements not illustrated by FIG. 3.

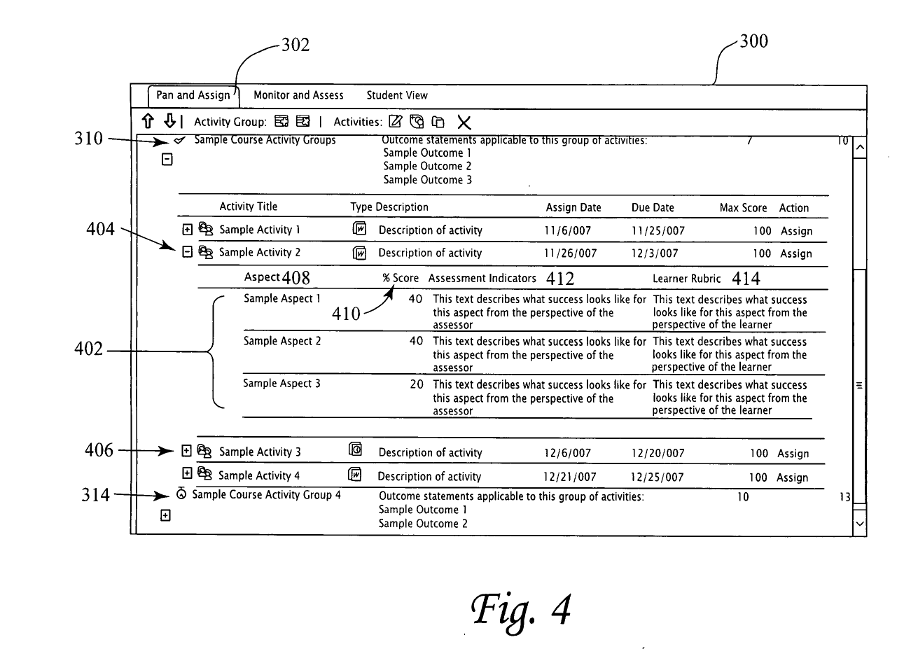

FIG. 4 illustrates an example plan and assign window 302 in accordance with various embodiments of the present technology. Specifically, the plan and assign window 302 can include the concept of gradable aspects 402, which can be associated with each electronic activity (e.g., 404 or 406). For example in one embodiment, it is noted that the course hub (e.g., 218) that generates the user interface 300 can support an advanced planning concept known as gradable aspects 402, where the educator can define specific areas of competency to be graded against. Note that the gradable aspects can include assessment indicators (as indicated an “Assessment Indicators” column 412) and a learner rubric (as indicated by a “Learner Rubric” column 414). For instance in an embodiment, each assessment indicator of column 412 can described what success looks like for the corresponding aspect from the perspective of the assessor. Furthermore, each learner rubric of column 414 can described what success looks like for the corresponding aspect from the perspective of the learner. It is pointed out that each of the activities (e.g., 404 or 406) can be targeted to specific learner groups to reflect individual learning needs.

The expanded view of the one or more electronic aspects 402 of each activity (e.g., 404) can include, but is not limited to, an “Aspect” column 408, a “% Score” column 410 that indicates what the percentage score or weighting is of the corresponding aspect in relation to its activity, the “Assessment Indicators” column 412 as described above, and the “Learner Rubric” column 414 as described above. It is pointed out that the expanded view of the one or more electronic aspects 402 of the plan and assign window 302 may not include all of the elements illustrated by FIG. 4. Additionally, the expanded view of the one or more electronic aspects 402 of the plan and assign window 302 can be implemented to include one or more elements not illustrated by FIG. 4.

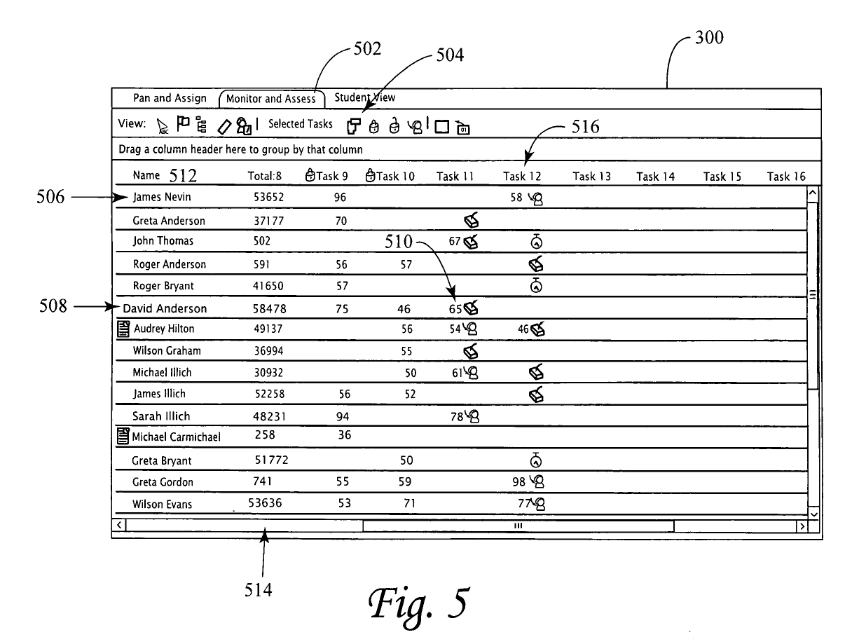

FIG. 5 illustrates an example monitor and access window 502 in accordance with various embodiments of the present technology. Specifically, the user interface 300 can include a “Monitor and Access” tab and corresponding window 502 that includes context sensitive communication “zones”. Furthermore, the monitor and access window 502 can be implemented as a matrix of individual learners (e.g. 506 and 508) and specific tasks (e.g., tasks 9-16). It is noted that communication between an educator and learner can be commonplace and increasingly takes the form of electronic communication. In most cases dialog is specific to a context, such as a course or an assignment within a course. Some of the typical reasons for electronic communication between learner and educator can be, but is not limited to: learner requests a clarification/information from educator around a course; learner requests a formal dispensation from the educator (such as an exception) around a course; learner requests a clarification/information from educator around a specific task; learner requests a formal dispensation from the educator (such as an extension) around a formal task; educator has information for all learners taking a specific course; educator has information for all learners assigned a specific task; educator has information for a specific learner taking a specific course; and educator has information for a specific learner assigned a specific task.

As such, the course hub (e.g., 118) can transform the educator/learner communications in different ways via the user interface 300. For example in one embodiment, within the user interface 300, the course hub (e.g., 118) can automatically generate the context and target audience of the communication based on the “zone” from which the communication can be initiated. Furthermore, via the user interface 300, the course hub (e.g., 118) can present a chat-style interface that groups each thread in a visual manner for easy readability. Additionally, via the user interface 300, the course hub (e.g., 118) can surface the contextually filtered discussion thread in an integrated manner at appropriate points in the assignment and grading workflow. For example in one embodiment, the course hub (e.g., 118) can produce via the user interface 300 visibility of the communication thread at contextually relevant times.

Within FIG. 5, in one embodiment the monitor and access window 502 can include, but is not limited to, four different context sensitive communication “zones”. Specifically, a first communication context can be for all learners and the entire course; a second communication context can be for a single learner and the entire course; a third communication context can be for all learners and a specific task; and a fourth communication context can be for a single learner and a specific task. It is noted that the specific task for the third and fourth communication contexts can be for a past, a current, or a future (e.g., unassigned) task.

More specifically in an embodiment, within the all learners and the entire course communication context, the educator can utilize or select icon 504 of the monitor and access window 502 in order to post a message that can be routed to all learners who are enrolled in the current course context. For example, this type of communication can be used for, but is not limited to, general announcements and information of interest to all. Within the single learner and the entire course communication context, the educator can post a message that will be routed to a single learner (e.g., 506) in the context of the entire course. For example, this type of communication might include, but is not limited to, coaching or feedback, exceptions and exclusion discussions or career guidance. In one embodiment, the educator can select the name of the single learner (e.g., 506) of the course in order to initiate the posting of the message to that learner.

Within the all learners and a specific task communication context, the educator can post a message that will be routed to all learners who are enrolled in the current course context and who have been assigned a specific task (e.g., Task 12). For example, this type of communication can be used to post an update about a specific assignment to just those taking that assignment, but is not limited to such. In one embodiment, the educator can select a task label (e.g., 516) of the course in order to initiate the posting of the message to those learners assigned that specific task (e.g., Task 12). Note that the single task context can be for a past task (e.g., Task 10), a present task (e.g., Task 12) or a future task (e.g., Task 13). Within the single learner and a specific task communication context, the educator can post a message that will be routed to a single learner (e.g., 508) who has been assigned a specific task (e.g., Task 11). For example, this type of communication can be used for private dialog specific to a task such as discussion around a request for extension or a draft review and redirection, but is not limited to such. In one embodiment, the educator can select an intersection point (e.g., 510) of a single learner (e.g., 508) and a specific task (e.g., Task 11) of the monitor and access window 502 in order to initiate the posting of the message to that learner regarding that specific task. It is pointed out that the single task context can be for a past task (e.g., Task 11), a present task (e.g., Task 12) or a future task (e.g., Task 16).

Within FIG. 5, the monitor and access window 502 can include, but is not limited to, a “Name” column 512 for the name of each student or learner of the specific course instance, a “Total” column 514 that indicates the total amount of points earned from one or more previously completed tasks (e.g., Tasks 1-8), which may not be shown, and a column for each remaining task (e.g., Tasks 9-16) to be completed by the students. It is pointed out that the monitor and access window 502 of the user interface 300 may not include all of the elements illustrated by FIG. 5. Furthermore, the monitor and access window 502 of the user interface 300 can be implemented to include one or more elements not illustrated by FIG. 5.

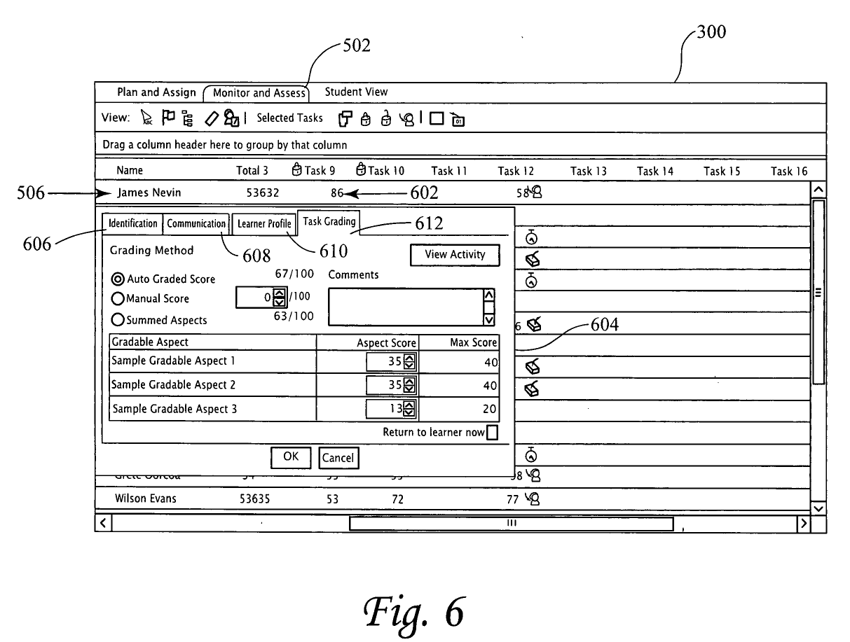

FIG. 6 illustrates an example three dimensional activity grading object window 604 in accordance with various embodiments of the present technology. Specifically, in one embodiment, the monitor and access window 502 can include a three dimensional (3D) activity grading object window 604 that is a three dimensional assessment object for each learner/task intersection. It is noted that traditionally the intersection point of a learner (e.g., row) and specific task (e.g., column) usually supports recording of a single value representing that learner's grade for the task. However, the course hub (e.g., 118) views an intersection point (e.g., 602) as an entry to a rich three dimensional object that maintains a linear record of a wide range of interactions related to the task, as illustrated by the three dimensional activity grading object window 604 (which in one embodiment can be implemented as a pop-up window). Specifically, within one embodiment of the monitor and access window 502, when an intersection point (e.g., 602) in a matrix of individual learners (e.g., 506 and 508) and specific tasks (e.g., task 9-16) is selected by a user, the course hub (e.g., 118) can generate a corresponding rich object (e.g., three dimensional object) that can include, but is not limited to, a timeline of events, interactions and communications in the context of the learner and task.

For example in one embodiment, the three dimensional activity grading object window 604 can include a navigation system that can include one or more categories. In an embodiment, the navigation system can include, but is not limited to, an “Identification” tab and window 606, a “Communication” tab and window 608, a “Learner Profile” tab and window 610, and a “Task Grading” tab and window 612. It is noted that the tabs and windows 606, 608, 610 and 612 can provide visibility and interaction opportunities for a wide range of data types. For instance in one embodiment, the visibility and interaction opportunities for a wide range of data types can include, but is not limited to, questions and answers; general discussions; formal requests (e.g., extension); educator feedback and advice; educator interim review and comment; redirection; peer review and feedback; access to entries in the process journal; grading iterations, retries and multiple attempts; qualitative final grading and remarks; and quantitative final grading and remarks. It is pointed out that these events (or interaction opportunities) can play a desirable role in assessment and learner tracking, which in turn are considered desirable components of 21^{st} century education.

Note that the Course Hub (e.g., 118) replaces the traditional, two dimensional, single value “grading cell” in a typical grade book with a rich, three dimensional, linear object collection (e.g., the three dimensional activity grading object window 604 and the user interface 300) that is able to track in one embodiment the entire history of interactions between a learner and educator around a specific task context, for the life of that task. This concept is expected to materially improve the efficiency and productivity of educators across all sectors of K-12 education along with Higher Education.

Within FIG. 6, it is noted that the three dimensional activity grading object window 604 of the monitor and access window 502 may not include all of the elements illustrated by FIG. 6. Additionally, the three dimensional activity grading object window 604 of the monitor and access window 502 can be implemented to include one or more elements not illustrated by FIG. 6.

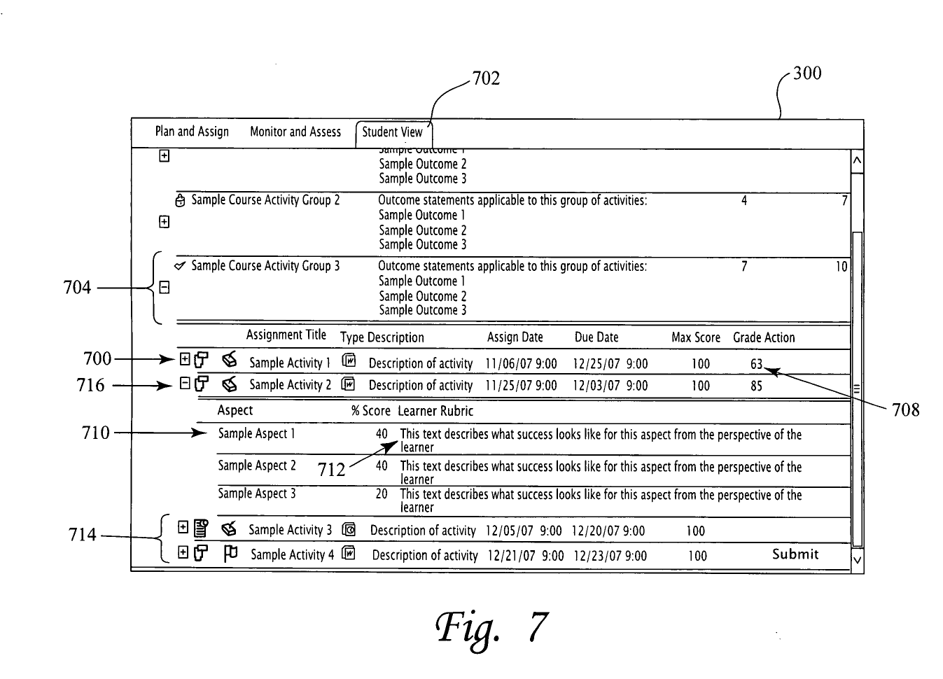

FIG. 7 illustrates an example student view window 702 in accordance with various embodiments of the present technology. Specifically, in one embodiment, the user interface 300 can include a “Student View” tab and corresponding window 702. It is noted that the student view window 702 can enable the learner to have visibility to course units past, present (e.g., 704) and future, including expected outcome descriptions. Furthermore, the learner can utilize the student view window 702 to interact with assigned activities (e.g., 706), including completing assessments, updating entries into a Process Journal and submitting completed work to the educator. The learner can see the score given (e.g., 708) for each task (e.g., 706) graded by the educator. Additionally, the student view window 702 can include assessable aspects (e.g., 710) of each activity (e.g., 716) along with a rubric (e.g., 712) that helps the learner understand what the educator is looking for them to demonstrate through this aspect of the task. Moreover, the student view window 702 enables the learner to have visibility also to ungraded and unassigned tasks (e.g., 714), which can allow the “what if” modeling to occur, described herein.

It is pointed out that the student view window 702 of the user interface 300 may not include all of the elements illustrated by FIG. 7. Furthermore, the student view window 702 of the user interface 300 can be implemented to include one or more elements not illustrated by FIG. 7.

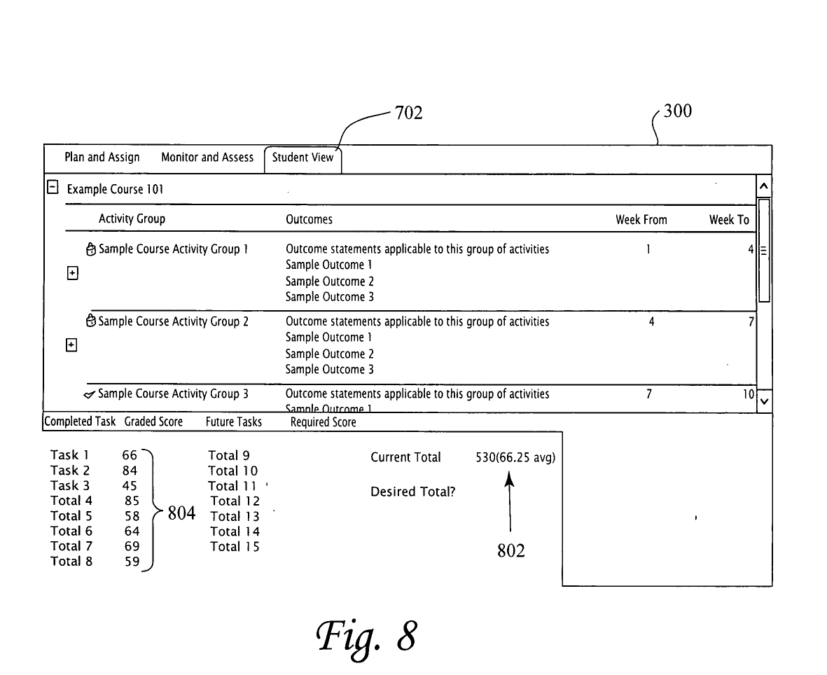

FIG. 8 illustrates an example student view window 702 in accordance with various embodiments of the present technology. Specifically, the student view window 702 of the user interface 300 can include a tabular view of learner tasks. For example in one embodiment, the learner can utilize the student view window 702 in order to view a current total score (e.g., 802) for the course overall derived from results (e.g., 804) for all completed tasks (e.g., Tasks 1-8). It is noted that the student view window 702 of the user interface 300 may not include all of the elements illustrated by FIG. 8. In addition, the student view window 702 of the user interface 300 can be implemented to include one or more elements not illustrated by FIG. 8.

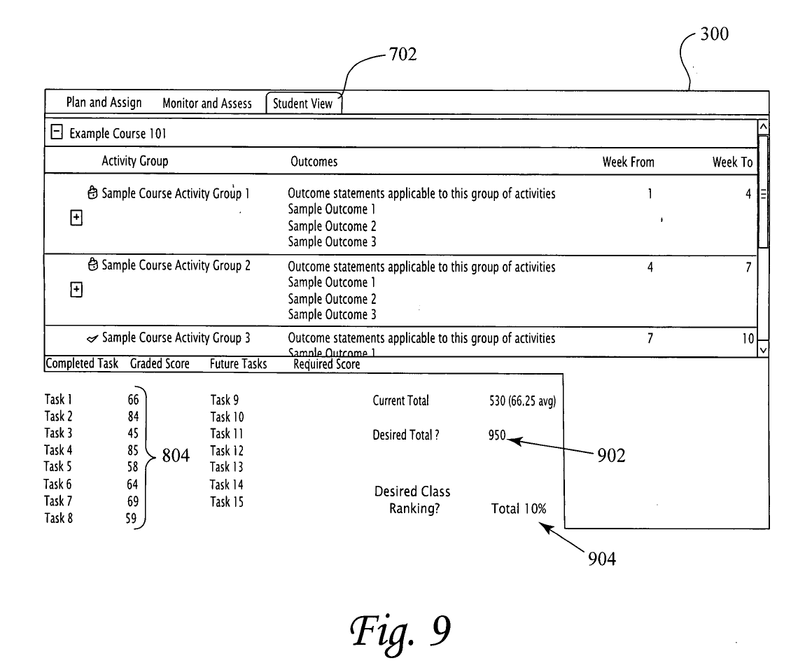

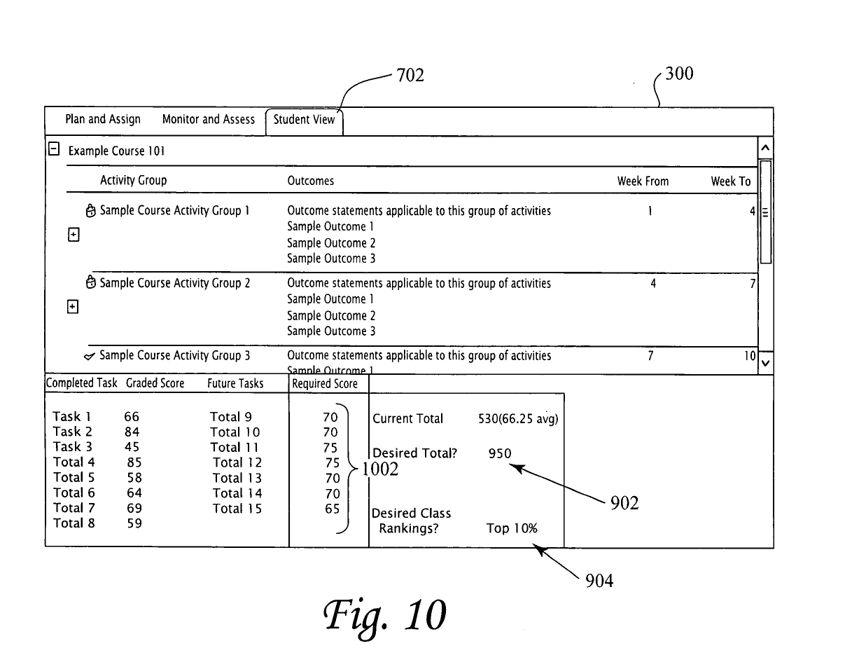

FIG. 9 illustrates an example student view window 702 in accordance with various embodiments of the present technology. Note that the Course Hub (e.g., 118) can present existing grades (e.g., 804) in real time along with a computed, interim course total (e.g., 802), but additionally, can supply visibility to future, as yet unassigned tasks with the ability to enter a “what if” or desired final grade (e.g., 902 of FIG. 9). When a desired final grade 902 is entered by a learner via the student view window 702, the Course Hub (e.g., 118) can apply one or more weighting formulas or rules defined by the educator to inform the learner what grades or scores (e.g., 1002 of FIG. 10) he or she are to achieve on the future assignments in order to be awarded the final grade for the course that is desired. Note that this “what if” determination by the course hub can be based on, but is not limited to, the results to date (e.g., 804) of completed tasks (if any) and the one or more weighting formulas or rules defined by the educator. It is pointed out that in one embodiment, this approach is consistent with the worldwide trend towards Outcomes Based Education that seeks to work with learners proactively on achieving desired outcomes as opposed to reactive correction after the fact.

Specifically in one embodiment, the student view window 702 of the user interface 300 can include a tabular view of learner tasks showing “what if” course total entry. For example in one embodiment, the learner can utilize the student view window 702 in order to enter a desired course total 902 that would typically align with an entry requirement for further study or qualification. Once the desired course total 902 is entered, FIG. 10 illustrates an example student view window 702 in accordance with various embodiments of the present technology that includes a tabular view of learner tasks showing “what if” course total entry (e.g., 902) and system generated projections. Specifically, in one embodiment, in response to the desired course total 902 being entered, the course hub (e.g., 118) can cause the student view window 702 to generate or produce a guideline as to how the learner is to score (e.g., 1002) on future tasks (e.g., Tasks 9-15) in order to achieve that desired outcome (e.g., 902), based on the results to date (e.g., 804), if any, and the weighting rules defined by the educator for those tasks.

In one embodiment, the “what if” assignment grade modeling associated with the student view window 702 of FIGS. 9 and 10 can utilize planned, but as yet unassigned tasks, presented in a linear format, that allows or enables a learner to gain insight into what scores they are to obtain on future tasks (or assignments) in order to receive a desired, overall course grade, based on results to date, if any.

Note that in an embodiment, the student view window 702 can be implemented to include normative comparison associated with the course. For example, the student view window 702 could be implemented to include the ability to enter a “what if” or desired class ranking (e.g., 904 of FIG. 9) associated with those learners currently enrolled in the course. When a desired class ranking 904 is entered by a learner via the student view window 702, the Course Hub (e.g., 118) can anonymously compare and utilize information of other learners enrolled in the course with information of the requesting learner to inform him or her what grades or scores (e.g., 1002 of FIG. 10) he or she are to achieve on the future assignments to possibly achieve the desired class ranking. Specifically, the Course Hub (e.g., 118) can anonymously compare and utilize information from learners such as, but not limited to, existing grades or scores (e.g., 804), interim course totals (e.g., 802), along with one or more weighting formulas or rules defined by the educator to inform the requesting learner what grades or scores (e.g., 1002 of FIG. 10) he or she are to achieve on the future assignments. Once the desired class ranking 904 is entered, FIG. 10 illustrates an example student view window 702 in accordance with various embodiments of the present technology that includes a tabular view of learner tasks showing “what if” class ranking entry (e.g., 904) and system generated projections. In one embodiment, in response to the desired class ranking 904 being entered, the course hub (e.g., 118) can cause the student view window 702 to generate or produce a guideline as to how the learner is to score (e.g., 1002) on future tasks (e.g., Tasks 9-15) in order to achieve that desired class ranking (e.g., 904), based on the results to date (e.g., 804), if any, the weighting rules defined by the educator for those tasks and the remaining tasks, and information or data of the other learners enrolled in the course.

It is pointed out that the student view window 702 of the user interface 300 may not include all of the elements illustrated by FIG. 9. Moreover, the student view window 702 of the user interface 300 can be implemented to include one or more elements not illustrated by FIG. 9. Note that the student view window 702 of the user interface 300 may not include all of the elements illustrated by FIG. 10. Additionally, the student view window 702 of the user interface 300 can be implemented to include one or more elements not illustrated by FIG. 10.

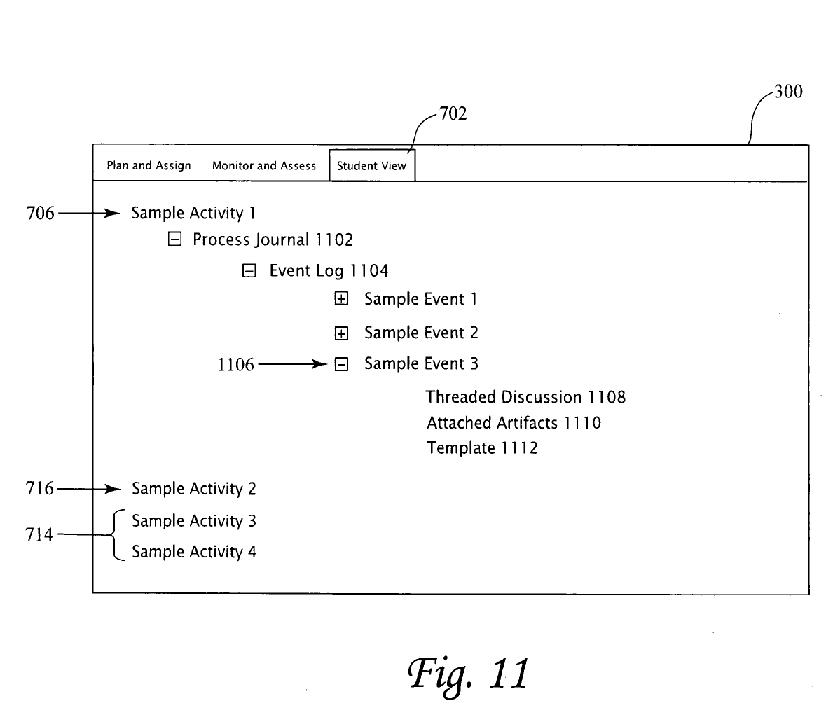

FIG. 11 illustrates an example assessable learner process journal 1102 in accordance with various embodiments of the present technology. It is noted that as the employment marketplace for skilled workers becomes increasingly competitive and demand for finite places in higher education courses increases, educators and learning institutions understand that there is an onus on them find more sophisticated means of assessing a learner's competency than just simple quizzes and the results of an assigned task. In one embodiment, the concept of the process journal 1102 is an approach to learner assessment that recognizes that the journey taken by the learner in the completion of an assignment can be every bit as assessable as the final result, and in many cases provides deeper insight into the learners thought processes and competencies than just the final result can. The course hub (e.g., 118) can generate a user interface (e.g., 300) that implements a viable Process Journal 1102 that can supply an event-based journal entry with a threaded discussion associated with each event and a collection of artifacts associated with each event and/or discussion thread post.

Specifically, in an embodiment, within the user interface 300 a process journal workspace 1102 can be automatically created by the course hub (e.g., 118) from a template for each learner and assignment (e.g., which the educator flags or indicates as having a process journal associated with it). Note that the learner can access the process journal 1102 by clicking through an activity (e.g., 706) listed in the student view window 702. Furthermore, the educator can access the process journal 1102 by invoking the three dimensional activity grading object 604 (FIG. 6) through the monitor and assess view 502. In addition, in one embodiment, the learner can be guided through steps or operations towards building the process journal 1102. For example, each step or operation can be commenced by making an entry in an event log 1104. Each event entry (e.g., 1106) can include, but is not limited to, a threaded discussion 1108 associated with it, the ability to attach artifacts 1110, and depending upon the type of event entry, a template 1112 optimized for the type of data the event relates to.

It is noted that the process journal 1102 of the user interface 300 may not include all of the elements illustrated by FIG. 11. Furthermore, the process journal 1102 of the user interface 300 can be implemented to include one or more elements not illustrated by FIG. 11.

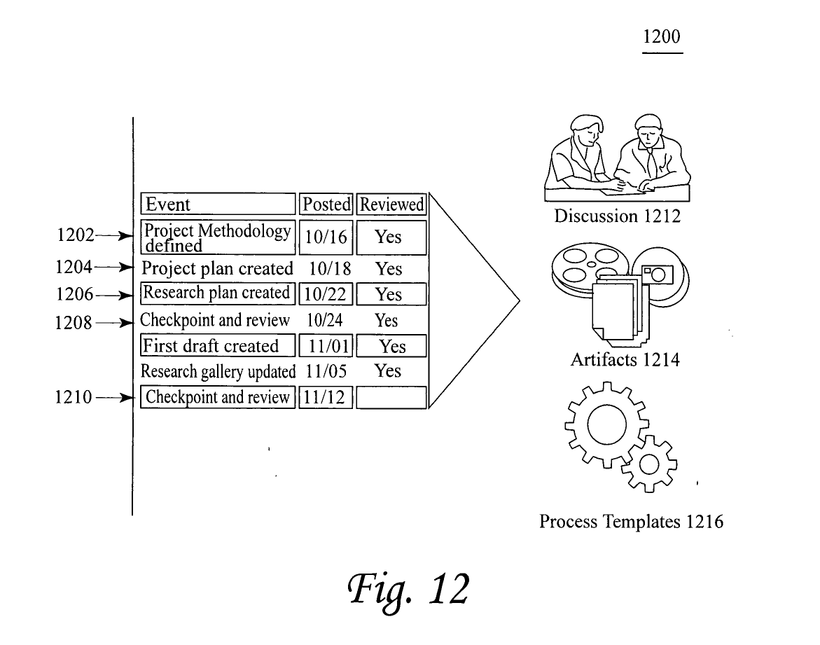

FIG. 12 is a block diagram illustrating a process journal concept 1200 in accordance with various embodiments of the present technology. It is noted that in one embodiment, one or more of the different features of the process journal concept 1200 can be incorporated into the process journal 1102 of the user interface 300. The process journal concept 1200 can support different event types, such as, but not limited to, planning methodology (e.g., 1202) and project plan (e.g., 1204), research methodology and artifacts, simple narrative, project execution methodology, checkpoints and reviews (e.g., 1208 and 1210) with the educator, redirections based on feedback and version iterations, raw materials and components used in the project, peer review of work in progress, final grades and comments, and learner reflections. In an embodiment, the educator can view the process journal at any time and engage with the learner via the discussion board (e.g., 1212) associated with each event entry. Furthermore, the educator can view the artifacts (e.g., 1214) associated with the event entry, including those generated through optimized templates (e.g., 1216), such as the project plan 1204. It is pointed out that the educator now has a rich device for making informed judgments and assessments of each learner's true ability that is materially in excess of just viewing the final work produced by each learner.

### Example Methods of Operation

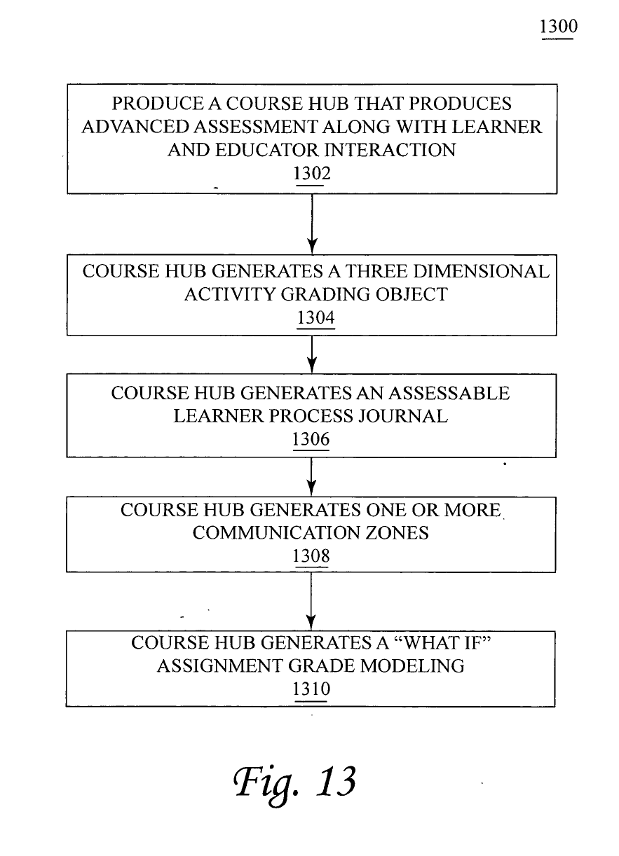

The following discussion sets forth in detail the operation of some example methods of operation of embodiments of the present technology for implementing one or more course hubs. FIG. 13 is a flow diagram of an example method 1300 for implementing one or more course hubs in accordance with various embodiments of the present technology. Flow diagram 1300 includes processes that, in various embodiments, are carried out by a processor(s) under the control of computer-readable and computer-executable instructions (or code), e.g., software. The computer-readable and computer-executable instructions (or code) may reside, for example, in data storage features such as computer usable volatile memory, computer usable non-volatile memory, peripheral computer-readable media, and/or computer usable mass data storage. The computer-readable and computer-executable instructions (or code), which may reside on computer useable media, are used to control or operate in conjunction with, for example, one or more processors of a computing device. However, the computing device readable and executable instructions (or code) may reside in any type of computing device readable medium. Although specific operations are disclosed in flow diagram 1300, such operations are examples. Method 1300 may not include all of the operations illustrated by FIG. 13. Also, embodiments are well suited to performing various other operations or variations of the operations recited in flow diagram 1300. Likewise, the sequence of the operations of flow diagram 1300 can be modified. It is appreciated that not all of the operations in flow diagram 1300 may be performed. It is noted that the operations of method 1300 can be performed by software, by firmware, by electronic hardware, by electrical hardware, or by any combination thereof.

It is noted that process 1300 can include producing a course hub that produces advanced assessment along with learner and educator interaction. The course hub can generate a three dimensional activity grading object. Additionally, the course hub can generate an assessable learner process journal. The course hub can generate one or more communication zones. Furthermore, the course hub can generate a “what if” assignment grade modeling.

At operation 1302 of FIG. 13, one or more course hubs (e.g., 116,118 and/or 120) can be produced (or generated or created) that produces advanced assessment of learning along with learner and educator interaction. It is noted that operation 1302 can be implemented in a wide variety of ways. For example, operation 1302 can be implemented in any manner similar to that described herein, but is not limited to such.

At operation 1304, the course hub can generate a three dimensional activity grading object (e.g., 300, 502 and 604). It is pointed out that operation 1304 can be implemented in a wide variety of ways. For example, operation 1304 can be implemented in any manner similar to that described herein, but is not limited to such.

At operation 1306 of FIG. 13, the course hub can generate an assessable learner process journal (e.g., 300 and 1102). Note that operation 1306 can be implemented in a wide variety of ways. For example, operation 1306 can be implemented in any manner similar to that described herein, but is not limited to such.

At operation 1308, the course hub can generate one or more communication zones (e.g., 300, 502, 504, 506, 510 and 516). It is noted that operation 1308 can be implemented in a wide variety of ways. For example, operation 1308 can be implemented in any manner similar to that described herein, but is not limited to such.

At operation 1310 of FIG. 13, the course hub can generate a “what if” assignment grade modeling (e.g., 300, 702, 902, 904 and 1002). It is pointed out that operation 1310 can be implemented in a wide variety of ways. For example in one embodiment, at any stage during a class, quarter, semester, or other grading period a student or learner can utilize an interface (e.g., 300) produced by the course hub at operation 1310 to do predictive modeling to determine what types of grades or scores would be needed to achieve a certain course outcome. For instance, if a student had received 80%'s on a number of assignments and there were three assignments left, the course hub can inform the student that he or she needs to achieve at least 95% on the last three assignments to reach their desired 90% goal for the course. In one embodiment, the course hub can track these models against their current grades and provide real-time feedback to each learner. As such, each learner could then modify their goals accordingly. Operation 1310 can be implemented in any manner similar to that described herein, but is not limited to such. At the completion of operation 1310, process 1300 can be exited. In this manner, one or more course hubs can be implemented in accordance with various embodiments of the present technology.

Example embodiments of the present technology are thus described. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for implementing a course hub, said method comprising:
generating a three dimensional activity grading object;
generating an assessable learner process journal;
generating a plurality of communication zones; and
generating a “what if” assignment grade modeling.

2. The computer-implemented method of claim 1, wherein said three dimensional activity grading object is activated via an intersection of a matrix comprising a learner and a task.

3. The computer-implemented method of claim 1, wherein said three dimensional activity grading object comprises a timeline of events for a learner.

4. The computer-implemented method of claim 1, wherein said three dimensional activity grading object comprises a communication in context of a learner and a task.

5. The computer-implemented method of claim 1, wherein said assessable learner process journal comprises a learner's task execution process.

6. The computer-implemented method of claim 5, wherein said learner's task execution process can be selected from the group consisting of planning, research, execution methodology, checkpoint, review, redirection, iteration, component review, and peer review.

7. The computer-implemented method of claim 1, wherein said plurality of communication zones comprises a threaded communication between an educator and a learner that is context specific.

8. The computer-implemented method of claim 1, wherein said “what if” assignment grade modeling comprises producing insight into what scores are to be obtained to receive a desired overall course grade.

9. A system for implementing a course hub, said system comprising:
an institutional portal for enabling an educator and a learner to interact with a course instance;
a course hub associated with the course instance, the course hub is for generating a three dimensional activity grading object, for generating an assessable learner process journal, for generating a plurality of communication zones, and for generating a “what if” assignment grade modeling.

10. The system of claim 9, wherein said institutional portal comprises a network access point.

11. The system of claim 9, wherein said institutional portal comprises a web site.

12. The system of claim 10, wherein said three dimensional activity grading object is activated via an intersection of a matrix comprising said learner and a task.

13. The system of claim 10, wherein said three dimensional activity grading object comprises a communication in context of said learner and a task.

14. The system of claim 11, wherein said assessable learner process journal comprises a learner's task execution process.

15. The system of claim 14, wherein said learner's task execution process can be selected from the group consisting of planning, research, execution methodology, checkpoint, review, redirection, iteration, component review, and peer review.

16. The system of claim 11, wherein said plurality of communication zones comprises a threaded communication between said educator and said learner that is context specific to a task.

17. A computer-readable medium having computer-executable instructions for performing a method for implementing a course hub, said instructions comprising:
generating a three dimensional activity grading object associated with a learner and a task of an educational course;
generating an assessable learner process journal that comprises said learner's task execution process; and
generating a plurality of communication zones that comprises a threaded communication between an educator and said learner that is context specific to said task.

18. The computer-readable medium of claim 17, further comprising:
generating a “what if” assignment grade modeling that comprises producing insight into scores that are to be obtained for remaining tasks to receive a desired overall course grade.

19. The computer-readable medium of claim 18, wherein said three dimensional activity grading object is activated via an intersection of a matrix comprising said learner and said task.

20. The computer-readable medium of claim 19, wherein said three dimensional activity grading object comprises a communication in context of a learner and a task.
